(19) United States
(12) Patent Application Publication
(10) Pub. No.: US 2012/0126709 A1
(43) Pub. Date: May 24, 2012

(54) Lighting System having a Power Supply Apparatus, Control Apparatus for a Lighting System, and Method for Controlling a Lighting System

(75) Inventor: Dirk BEINER, Paderborn (DE)

(73) Assignee: Traxon Technologies Europe GmbH, Paderborn (DE)

(21) Appl. No.: 13/240,646

(22) Filed: Sep. 22, 2011

(30) Foreign Application Priority Data
Sep. 22, 2010 (DE) 10 2010 046 299.3

(51) Int. Cl. H05B 37/02

(52) U.S. Cl. 315/152

(57) ABSTRACT

A lighting system comprising a power supply apparatus (2) which has a power generation unit (21), which is suitable for generating a direct current, and an energy storage unit (22) for storing energy from the power generation unit (21), and further comprising a lighting means unit (3) which comprises a plurality of lighting means (31), which can be operated with a direct current, and which is connected to the energy storage unit (22) in order to be supplied with a direct current, wherein no apparatus for converting a direct current into an alternating current or an alternating current into a direct current is arranged between the power generation unit (21) and the lighting means (31). A control apparatus (4) for the lighting system (1) and a method for controlling the lighting system (1) are also disclosed.

### RELATED APPLICATIONS

A claim is made to the priority of German patent application 10 2010 046 299.3 filed Sep. 22, 2010, the disclosure content of which is hereby incorporated by reference.

### FIELD OF THE INVENTION

The invention relates to a lighting system having a power supply apparatus, to a control apparatus for a lighting system, and to a method for controlling a lighting system.

### BACKGROUND OF THE INVENTION

Regenerative energies, in particular solar energy, are increasingly being used for supplying power. In photovoltaic systems which, in particular, are also used in private households, a direct current is generated in solar cells, said direct current being fed to an energy storage means, for example a rechargeable battery. The energy which is stored in the rechargeable battery is generally converted into an AC voltage, for example a 230 volt AC voltage, which is suitable for domestic power supply by means of an inverter, in order to be able to connect commercially available lighting means and other electrical loads to said AC voltage. In this case, the photovoltaic system and the lighting system are controlled independently of one another

### SUMMARY OF THE INVENTION

One object of the invention is to provide a lighting system having a power supply apparatus which is distinguished by improved efficiency and, as a result, relatively low power consumption. Another object of the invention is to provide a control apparatus, which is suitable for controlling the lighting system. A further object of the invention is to provide an advantageous method for controlling the lighting system.

According to one aspect of the invention, the lighting system comprises a power supply apparatus which has a power generation unit, which is suitable for generating a direct current, and an energy storage unit for storing energy from the power generation unit. The lighting system also comprises a lighting means unit which comprises a plurality of lighting means, which can be operated with a direct current, and which is connected to the energy storage unit in order to be supplied with a direct current. Advantageously, no apparatus for converting a direct current into an alternating current or an alternating current into a direct current is arranged between the power generation unit and the lighting means.

Since lighting means which can be operated with a direct current are used in the lighting means unit of the lighting system, said lighting means can be connected directly to the energy storage unit of the power supply apparatus which is suitable for generating a direct current, wherein, in particular, no apparatus for converting a direct current into an alternating current is arranged between the power generation unit and the lighting means.

The lighting system does not comprise an apparatus for converting an alternating current into a direct current either, this being required, for example, if lighting means which can be operated with a direct current were required to be operated with the customary AC voltage of a domestic power supply. In particular, power supply units between the power generation unit and the lighting means can be dispensed with.

Since no apparatuses for converting a direct current into an alternating current or an alternating current into a direct current are used in the lighting system, the losses which are otherwise produced during conversion operations are avoided. This improves the efficiency of the lighting system and reduces the power consumption.

The lighting means of the lighting unit can comprise, in particular, one or more LED light sources. The LED light sources can be individual LEDs or LED arrangements, for example LED arrays. The LED light sources can also contain flat LED lighting means which are, in particular, organic LEDs (OLEDs).

The power generation unit of the power supply apparatus can be, in particular, a photovoltaic system. The photovoltaic system can have a large number of solar cells which generate a direct current which is fed to an energy storage unit.

The energy storage unit of the power supply apparatus can be, in particular, a rechargeable battery. The rechargeable battery serves as a buffer store for the power which is generated preferably by means of a photovoltaic system.

In a preferred refinement, the power supply apparatus and the lighting means unit have a common control apparatus. Control of the power supply apparatus, in particular of a photovoltaic system, and control of the lighting means unit are thus advantageously integrated in a single device and/or are performed in correlation with one another.

The control apparatus is preferably connected to the power supply apparatus by a data line which is suitable for bidirectional data transmission. In particular, the control apparatus of the power supply apparatus can receive data via the incoming and/or stored energy. The control apparatus is suitable, in particular, for controlling the lighting means as a function of the data in the incoming and/or stored energy. By way of example, the control apparatus can reduce the intensity and/or the number of the operated lighting means at low values of the stored energy and/or incoming energy, in order to be able to maintain a minimum lighting level, which is predefined for an intended lighting purpose, over as long a period of time as possible.

Since the power which is generated in the power generation unit depends on the intensity of the incident sunlight in the case of photovoltaic systems, the data in the incoming energy, which data is acquired by the control unit, is used to control the lighting means unit depending on the brightness of the day. In this case, the power generation unit simultaneously advantageously operates as a brightness sensor for controlling the lighting means unit.

The control apparatus can preferably take into account a prediction for the incoming energy over a foreseeable period of time when controlling the lighting means. The prediction can be based, in particular, on a weather forecast. To this end, the control apparatus is advantageously connected to a weather station and/or designed to receive weather data via the Internet.

The control apparatus is also preferably designed to control the power generation unit, in particular a photovoltaic system. In particular, the control apparatus can be designed to orient a photovoltaic system in accordance with the position of the sun in order to make use of the incident sunlight for power generation in a particularly efficient manner.

The control apparatus is advantageously connected to the lighting means unit by a further data line which is suitable for data transmission. The data line is preferably suitable for bidirectional data transmission. The signals which are transmitted from the control apparatus to the lighting means unit comprise, in particular, the information relating to the intensity at which the lighting means should be operated. The control apparatus can preferably receive data relating to the operating state of the lighting means from the lighting means unit, for example the operating temperature and/or the current power consumption of the lighting means.

The lighting means unit can also have one or more sensors in order to measure, for example, the intensity of the daylight which is incident in an area which is to be illuminated. The control apparatus can advantageously control the lighting means as a function of this data in such a way that a desired lighting intensity is achieved in the area which is to be illuminated.

The control apparatus described here for a lighting system is designed to control a lighting means unit which comprises a plurality of lighting means which can be operated with a direct current, and to control a power supply apparatus which is designed to supply a direct current to the lighting means unit.

To this end, the control apparatus preferably has at least one interface for transmitting data to the lighting means unit and advantageously also to receive data from the lighting means unit. The control apparatus also has a further interface for transmitting data to the power supply apparatus and advantageously also for receiving data from the power supply apparatus.

The control apparatus is advantageously designed to receive weather data from a weather station and/or the Internet.

Further advantageous refinements of the control apparatus can be found in the refinements of the control apparatus which are described in connection with the lighting system, and vice versa.

In a method for controlling the above-described lighting system, the power supply device and the lighting means unit of the lighting system are controlled by a common control apparatus.

The power generation unit of the power supply apparatus can be, in particular, a photovoltaic system, wherein the photovoltaic system is oriented by means of the control apparatus as a function of the position of the sun. To this end, the photovoltaic system has, for example, a motor system for orienting the solar cells in accordance with the angle of incidence of the sunlight. Data relating to the angle of incidence of the sunlight as a function of the date and time are advantageously stored in the control apparatus.

In the method, an amount of energy which is stored in the energy storage unit of the power supply apparatus is also advantageously ascertained by the control apparatus and the lighting means unit is controlled as a function of the stored amount of energy. By way of example, the control apparatus can switch off individual lighting means of the lighting means unit and/or reduce the intensity of said lighting means if the amount of energy stored in the energy storage unit falls below a setpoint value.

The lighting means unit is further preferably controlled by means of the control apparatus as a function of weather data which is received from the Internet and/or from a weather station. By way of example, the lighting means can be operated in an energy-saving mode if, on the basis of the weather forecast, it is predicted that the incoming energy over a foreseeable period of time is low. Therefore, the control apparatus can use both the current status of the energy storage means and also a prediction for the amount of energy which can be expected to be input into the power generation unit in the future to control the lighting means unit. The lighting system is therefore distinguished by an anticipatory energy management system.

Further advantageous refinements of the method can be found in the refinements which are described above in connection with the lighting system and the control apparatus, and vice versa.

### BRIEF DESCRIPTION OF THE SINGLE DRAWINGS

FIG. 1 shows a lighting system having a power supply apparatus according to an exemplary embodiment of the invention.

### DETAILED DESCRIPTION OF THE SINGLE DRAWING

The constituent parts which are illustrated in the drawing and the relative sizes of the constituent parts with respect to one another are not to be regarded as being true to scale.

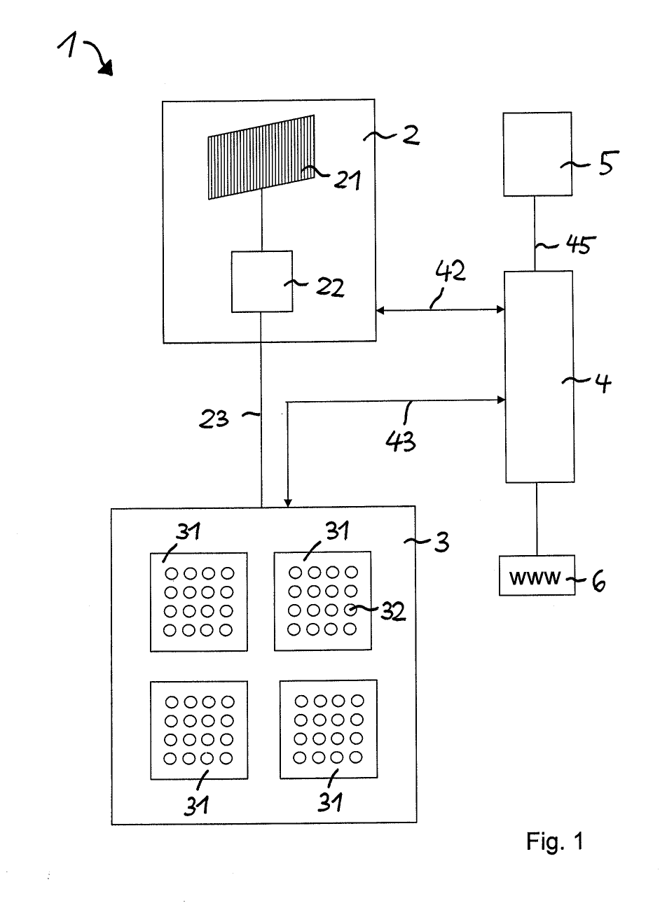

The lighting system 1 which is illustrated in FIG. 1 contains a lighting means unit 3. The lighting means unit 3 comprises a plurality of lighting means 31 which can be operated with a direct current. The lighting means 31 are, in particular, LED light sources which each have one or more LEDs 32. By way of example, the lighting means 31 can be LED arrays, as illustrated in FIG. 1. However, as an alternative, it is also possible for one or more lighting means 31 to have just one individual LED.

The lighting means 31 can have, for example, LEDs 32 which emit white light. As an alternative, it is also possible for the lighting means 31 to have colored or varicolored LEDs 32 which allow a large number of lighting colors, for example by means of additive color mixing.

The lighting means 31 may also be organic LEDs which can be designed, in particular, as flat light sources. The lighting means unit 3 can also contain, in particular, various types of lighting means 31 which can be operated with a direct current.

The lighting means unit 3 is connected to a power supply apparatus 2 for power supply purposes. The power supply apparatus 2 contains a power generation unit 21 and an energy storage unit 22. The power generation unit 21 is suitable for generating a direct current, wherein the power generation is advantageously based on the use of regenerative energy. The power generation unit 21 can be, in particular, a photovoltaic system.

The power supply apparatus 2 also comprises an energy storage unit 22 which can be, in particular, a rechargeable battery. The direct current which is generated by means of the power generation unit 21 is fed to the energy storage unit 22 and temporarily stored there.

The energy storage unit 22 operates as a direct current source for the lighting means unit 3. The lighting means unit 3 is preferably directly connected to the energy storage unit 22 of the power supply apparatus 2 by means of at least one power line 23 through which direct current flows. In particular, there is no apparatus for converting a direct current into an alternating current or an alternating current into a direct current between the energy storage unit 22 and the lighting means 31. That is to say, the energy which is stored in the energy storage unit 22 is not converted into a power supply grid AC voltage of, for example, 230 volts as is customary, but rather the lighting means unit 3 is directly connected to the energy storage unit 22 which operates as a direct current source. In this way, losses which occur during conversion of a direct current into an alternating current are avoided.

Furthermore, it is not necessary to equip the lighting means unit 3 with a power supply unit for converting an alternating current into a direct current either, this generally being necessary in the case of operation of LED light sources 31 with a power supply grid voltage. Since conversion of a direct current into an alternating current and vice versa are avoided in the lighting system 1, the lighting system 1 is distinguished by improved efficiency and therefore lower power consumption.

The lighting system 1 also has a control apparatus 4 which controls both the power supply apparatus 2 and the lighting means unit 3. The power supply apparatus 2 and the lighting means unit 3 are, in particular, not controlled independently of one another, but rather they are advantageously controlled in a coordinated manner by the common control apparatus 4 using data which the control apparatus 4 receives from the power supply apparatus 2 and the lighting means unit 3.

The control apparatus 3 is advantageously connected to the power supply apparatus 2 by means of a bidirectional data line 42. The control apparatus 4 can receive from the power supply apparatus 2, in particular, data relating to the amount of energy which is stored in the energy storage unit 22 and the amount of energy which is currently generated by means of the power generation unit 21.

The control apparatus 4 is also connected to the lighting means unit 3 by a preferably bidirectional data line 43. The control apparatus 4 can transmit, in particular, control signals to the lighting means unit 3 via the data line 43 in order to generate a desired lighting situation by means of the lighting means 31. In particular, the control apparatus 4 can take into account the state of charge of the energy storage unit 22 when controlling the lighting means unit 3. By way of example, the lighting means unit 3 can be automatically operated in an energy-saving mode when there is a low state of charge in the energy storage unit 22. It is possible, for example, for individual LEDs 32 of the lighting means 31 to be switched off and/or for the lighting means 31 to be operated with a lower power in order to save energy.

In a preferred refinement, the control apparatus 4 takes into account both the current state of charge of the energy storage unit 22 and also a prediction for the amount of energy which can be generated in the power generation unit 21 over a foreseeable period of time during operation of the lighting means unit 3.

If the power generation unit 21 is a photovoltaic system, the generated power is dependent, in particular, on the position of the sun and the weather conditions. In order to receive up-to-date data regarding the position of the sun and/or the weather conditions, the control apparatus 4 is advantageously connected to a weather station 5 by means of a data line 45. As an alternative or in addition, the control apparatus 4 can be connected to the Internet 6 by means of a data line 46 in order to receive, in particular, data relating to the position of the sun or predictions for developments in the weather conditions. The control apparatus 4 can, for example, use the data which is received from the weather station 5 and/or from the Internet 6 to reduce the power consumed by the lighting means 31 if a low level of power can be expected to be generated in the power generation unit 21 on account of a low level of solar irradiation being expected.

If the power generation unit 21 is a photovoltaic system, the control apparatus 4 is preferably designed to orient the photovoltaic system as a function of the position of the sun. To this end, the control apparatus 4 can evaluate stored data and/or the data which is received from the weather station 5 and/or from the Internet 6. The solar cells which are contained in the photovoltaic system 21 can be oriented, for example by means of a suitable motor arrangement, in such a way that they absorb the incident sunlight as well as possible. Since photovoltaic systems have an optimal operating point at a specific temperature, it is also feasible to use the waste heat from the lighting means unit 3 for heating purposes, and therefore for increasing the efficiency of the photovoltaic system, on cold days.

It is also advantageous if the control apparatus 4 receives operating data from the lighting means 31 via the bidirectional data connection 43 and evaluates said data for the purpose of controlling said lighting means. In particular, the control apparatus 4 can receive the data relating to the power consumption of the individual lighting means 31. It is also possible for the lighting means unit 3 to comprise one or more sensors which measure, for example, the operating temperature of the LEDs 32 and/or the ambient brightness. If the lighting means unit 3 contains, for example, an ambient light sensor, the control apparatus 4 can match the power of the lighting means 31 to the ambient brightness, in particular to a varying incidence of daylight. In particular, the control apparatus 4 can be designed to realize a lighting situation which is predefined by a user using the existing power supplies in the best possible manner. In the case of a lighting means unit 3 which emits white light, in which the generation of white light is based, for example, on additive color mixing of colored LEDs, the color temperature may possibly be changed in order to achieve a predefined light intensity together with a relatively low level of power consumption.

The invention is not restricted by the description on the basis of the exemplary embodiments. Rather, the invention covers any novel feature and also any combination of features, which in particular includes any combination of features in the patent claims, even if this feature itself or this combination of features itself is not explicitly specified in the patent claims or exemplary embodiments.

We claim:

1. A lighting system comprising:
a power supply apparatus including a power generation unit, which is suitable for generating a direct current, and an energy storage unit for storing energy from the power generation unit; and
a lighting means unit which comprises a plurality of lighting means, adapted to be operated with a direct current, and which is connected to said energy storage unit in order to be supplied with a direct current,
wherein no apparatus for converting a direct current into an alternating current or an alternating current into a direct current is arranged between said power generation unit and said lighting means.

2. The lighting system according to claim 1, wherein said lighting means comprises one or more LED light sources.

3. The lighting system according to claim 1, wherein said power generation unit is a photovoltaic system.

4. The lighting system according to claim 1, wherein said energy storage unit is a rechargeable battery.

5. The lighting system according to claim 1, wherein said power supply apparatus and said lighting means unit have a common control apparatus.

6. The lighting system according to claim 5, wherein said control apparatus is connected to the power supply apparatus by a data line which is adapted for bidirectional data transmission.

7. The lighting system according to claim 5, wherein said control apparatus is connected to a weather station and/or is configured to receive weather data via the Internet.

8. The lighting system according to claim 5, wherein the control apparatus is configured to control said lighting means unit as a function of a prediction for the amount of energy which can be expected to be input into said power generation unit in the future.

9. The lighting system according to claim 5, wherein said control apparatus is connected to said lighting means unit by a further data line which is adapted for bidirectional data transmission.

10. A control apparatus for a lighting system, which is configured:
to control a lighting means unit which comprises a plurality of lighting means which are adapted to be operated with a direct current; and
to control a power supply apparatus which is adapted to supply the lighting means unit with a direct current.

11. The control apparatus according to claim 10, wherein the control apparatus is configured to receive weather data from a weather station and/or from the Internet, and wherein the control apparatus is configured to control the lighting means unit as a function of a prediction for the amount of energy which can be expected to be input into the power generation unit in the future.

12. A method for controlling a lighting system according to claim 1, wherein the power supply apparatus and the lighting means unit are controlled by a common control apparatus.

13. The method according to claim 12, wherein the power generation unit is a photovoltaic system, and the photovoltaic system is oriented by means of the control apparatus as a function of the position of the sun.

14. The method according to claim 12, wherein an amount of energy which is stored in the energy storage unit is ascertained by the control apparatus and the lighting means unit is controlled as a function of the stored amount of energy.

15. The method according to claim 12, wherein the lighting means unit is controlled by the control apparatus as a function of weather data which is received from the Internet and/or from a weather station and from which a prediction for the amount of energy which can be expected to be input into the power generation unit in the future is calculated.
